(19) United States
(12) Patent Application Publication
(10) Pub. No.: US 2001/0015558 A1
(43) Pub. Date: Aug. 23, 2001

(54) Latch mechanism

(75) Inventors: Sydney Edward Fisher, Solihull (GB); Timothy Bland, Plymouth, MI (US)

Correspondence Address: Karin H. Butchko, Carlson, Gaskey & Olds, P.C., Suite 350, 400 W. Maple, Birmingham, MI, 48009, US

(73) Assignee: Meritor Light Vehicle Systems (UK) Limited

(21) Appl. No.: 09/784,991

(22) Filed: Feb. 16, 2001

(30) Foreign Application Priority Data
Feb. 18, 2000 (GB) GB0003688.9

(51) Int. Cl. E05C 3/06

(52) U.S. Cl. 292/216

(57) ABSTRACT

A vehicle door latch mechanism including safety structural components. The latch mechanism includes a latch bolt having a closed condition capable of retaining a striker and an open condition capable of releasing the striker, a pawl which in use releasably secures the latch bolt in its closed condition, and a retention plate. The retention plate includes at least one mouth which co-operates with a retention means to releasably retain the striker in the mouth, at least one pivot pin hole defining a pivot pin hole surface for a pivot pin which is secured to the retention plate in the hole or is pivotally mounted in the hole, and at least one fixing means for fixing a latch mechanism in its operating position. The latch bolt, pawl and retention plate co-operate in use to releasably retain a striker in which at least one of the said safety critical structural components is made from a plurality of structural laminations of material.

### BACKGROUND OF THE INVENTION

The present invention relates generally to a vehicle door latch mechanism, and in particular a latch mechanism having a latch bolt, a pawl, and a retention plate.

Latch mechanisms are known in which a latch bolt is pivotally secured to a retention plate, the latch bolt having a closed condition in which it is capable of retaining a striker and an open condition at which it is capable of releasing the striker. Such known latch mechanisms further include a pawl for releasably securing the latch bolt in its closed condition. The retention plate typically has a mouth which co-operates with the claw and pawl to releasably retain the striker in the mouth. The latch bolt and the pawl are moving components of the latch mechanism, whereas the retention plate is a stationary component.

The retention plate further includes a pivot pin, either being secured to the retention plate or being pivotally mounted in the retention plate, the pivot pin acting to pivot the latch bolt or pawl. The retention plate also includes fixing means, such as fixing holes for fixing the latch mechanism in its operating position on a door.

When a vehicle is involved in a road accident, the latch mechanism is designed to prevent the door from opening. The retention plate, the latch bolt and the pawl are designed to resist high impact loads and are thus crash protection safety critical structural components since by keeping the door closed during a crash the integrity of the vehicle safety cell is maintained.

Hence, there is a need in the art for an improved vehicle door latch mechanism and in particular a latch mechanism having a latch bolt, a pawl, and a retention plate.

### SUMMARY OF THE INVENTION

The present invention relates generally to a vehicle door latch mechanism, and in particular a latch mechanism having a latch bolt, a pawl, and a retention plate.

According to the present invention, there is provided a vehicle door latch mechanism including a latch bolt, a pawl, and a retention plate. The latch bolt has a closed condition at which it is capable of retaining a striker and an open condition at which it is capable of releasing the striker. The pawl in use releasably secures the latch bolt in its closed condition. The retention plate includes at least mouth co-operating with a retention means of the latch mechanism to releasably retain the striker in the mouth, at least one pivot pin hole defining a pivot pin hole surface for a pivot pin which is secured to the retention plate in the hole or being pivotally mounted in the hole, and at least one fixing means for fixing the latch mechanism in its operating position. The latch bolt, pawl and retention plate co-operate in use to releasably retain the striker.

At least one of the said safety critical structural components is made from a plurality of structural laminations of material. Advantageously, this allows for increasing the strength of the retention plate, latch bolt or pawl in a specific application by the addition of a further lamination. Furthermore, it allows for lighter components since tabs of the pawl, claw or retention plate can be formed from a single lamination. Typically, such tabs only see relatively light loads associated with operation of the latch mechanism. In particular, such tabs do not undergo heavy loads when the vehicle is involved in a road accidence since other parts of the pawl, claw or retention plate are designed to withstand such high loads.

Accordingly, the present invention provides a vehicle door latch mechanism and in particular a latch mechanism having a latch bolt, a pawl, and a retention plate.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows.

FIG. 1 is a perspective view of a retention plate according to the present invention.

FIG. 2 is a perspective view of a latch bolt according to the present invention.

FIG. 3 is an perspective view of a pawl according to the present invention.

FIG. 4 is a view taken in the direction of arrow A of FIG. 1 wherein the retention plate, latch bolt and pawl are in their assembled positions.

### DETAILED DESCRIPTION OF THE PREFERRED EMBODIMENT

With reference to the figures there is shown a latch mechanism 10 comprising a retention plate 12, a latch bolt 14 and a pawl 16.

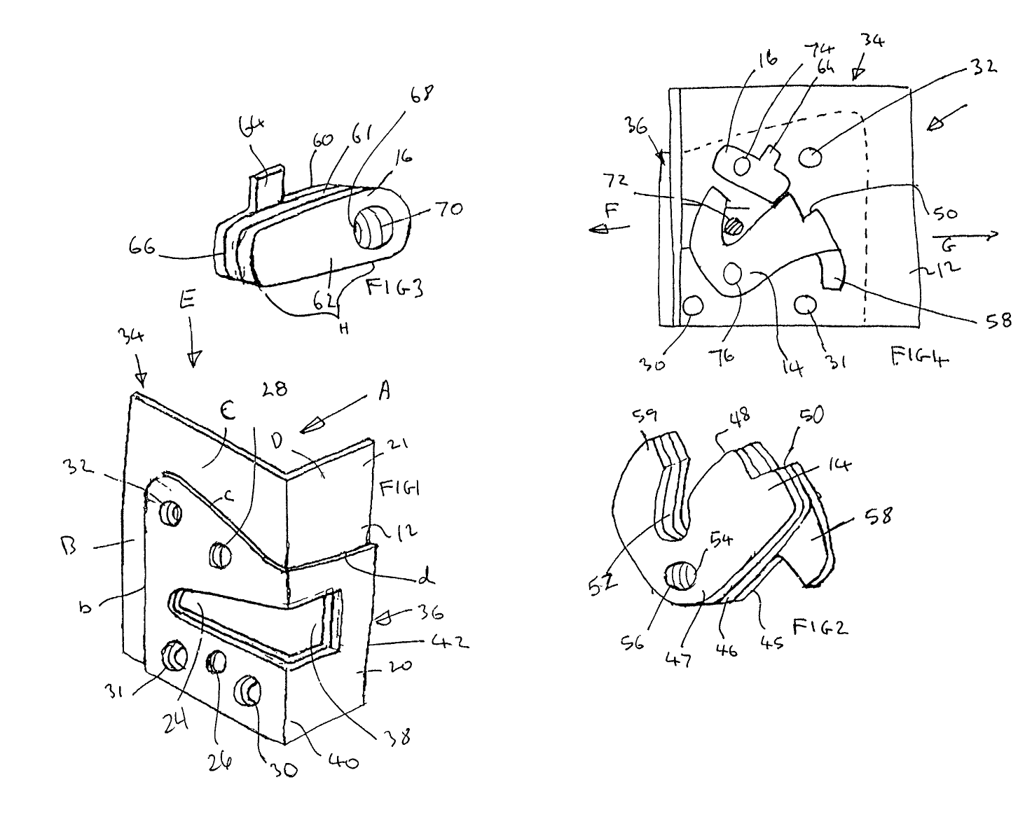

As illustrated in FIG. 1, retention plate 12 is made up of two laminations 20 and 21 made of a structural material such as steel. The laminations 20 and 21 are in face to face relationship. In this case, the profile of lamination 20 is different from the profile of lamination 21, lamination 21 including areas B, C and D which extend beyond the respective edges b, c, and d of lamination 20. The retention plate assembly includes a mouth 24, a latch bolt pivot pin hole 26, a pawl pivot pin hole 28 and fixing holes 30, 31 and 32.

In this case, the retention plate 12 is generally L shaped when viewed from above in the direction of arrow E having a first leg 34 and second leg 36. Mouth 24 is provided in leg 34 and leg 36 includes a corresponding mouth cut out 38. In particular, both mouth 24 and mouth cut out 38 extends to the common edge 40 of the retention plate assembly 12 where legs 34 and 36 meet. Mouth cut out 38 does not extend to edge 42 (of leg 36) remote from common edge 40.

It can be seen that the two laminations 20 and 21 combine to form mouth 24, a latch bolt pivot pin hole 26, and pawl pivot pin hole 28 and fixing hole 30, 31 and 32.

With reference to FIG. 2, there is shown a latch bolt assembly 14 having three laminations 45, 46 and 47 each of a structural material such as steel. Latch bolt assembly 14 includes a closed abutment surface 48, a first safety abutment 50, a retention surface 52 and a pivot pin hole 54 defining a pivot pin surface 56.

Laminations 46 and 47 are identical, and lamination 45 differs only in as much as it includes tab 58. It can be seen that laminations 45, 46 and 47 combine to form closed abutment surface 48, first safety abutment 50, retention surface 52 and pivot pin surface 56.

With reference to FIG. 3 there is shown a pawl assembly 16 comprising three laminations 60, 61 and 62 each of a structural material such as steel. Laminations 61 and 62 are identical and lamination 60 differs only in as much as it includes a tab 64. The pawl assembly 16 includes an abutment surface 66 and a pivot pin hole 68 defining a pivot pin surface 70. It can be seen that laminations 61, 62 and 63 combine to form abutment surface 66 and pivot pin surface 70.

FIG. 4 illustrates the various components of the latch mechanism 10 in their assembled position such that the latch mechanism 10 is in a closed position retaining the striker 72 in mouth 24.

In particular, pivot pins 74 and 76 allow the pawl assembly 16 and latch bolt assembly 14, respectively, to rotate. Depending on the particular design of the latch mechanism 10, pivot pin 74 could be an interference fit in hole 28 and a clearance fit in hole 70 allowing the pawl to rotate on the pin. Alternatively, pivot pin 74 could be an interference fit in hole 70 and a clearance fit in hole 28 allowing the pawl 16 and pin 74 to rotate in unison relative to the retention plate assembly. Similar alternative arrangements for pivot pin 76 in holes 26 and 54 are also possible.

In the preferred embodiment, fixing holes 30, 31 and 32 are threaded holes, the threads being formed after the laminations 20 and 21 have being assembled. Thus the threaded portions in lamination 20 correctly align with the threaded portions in lamination 21 allowing a threaded fitting such a bolt to be threaded into the holes 30, 31 and 32.

In the event of road traffic accident in which forces act to attempt to open the door, the latch assembly 10 secured to the door is forced in the direction of arrow G relative to the striker 72 which is secured to the door aperture. Consideration of the various forces involved show that whilst the retention plate 12, latch bolt 14 and pawl 16 are safety critical structural components, only certain parts of these components suffer loads associated with the impact. For example, portion H of pawl assembly 16 undergoes a compressive load as does abutment surface 66 and parts of pivot pin surface 70, whereas tab 64 undergoes no such loading.

Similarly, impact stresses will be developed in retention surface 52 which contacts the striker 72, close abutment surface 48 which contacts abutment surface 66 of the pawl, and first safety abutment surface 50 which also contacts abutment surface 66 of the pawl when the latch mechanism 10 is in a first safety position (i.e. the door is secured from opening but not in a fully closed position). Parts of pivot pin surface 56 will also undergo high loads.

Consideration of the forces involved in the retention plate assembly 12 during impact show that the fixing holes 30, 31 and 32 have to be strong enough to ensure that the latch mechanism 10 is retained on the associated door, pivot pin holes 26 and 28 have to be strong enough to be ensure that their edges to not collapse and allow the associated pivot pins 76, 74 to escape therefrom, and mouth 24 has to be strong enough to ensure that the mouth 24 does not open up allowing the striker 72 to escape over the end 59 of the latch bolt assembly 14.

It can be seen that there is a circular force path wherein an action force applied by the striker 72 to the mouth 24 of the latch bolt 14 is transferred to pivot 76 then to retention plate 12 then to pivot 74 then to pawl 16 and finally resulting in a reaction force on the closed abutment surface 48 of the latch boltl4.

In particular areas B, C and D of the retention plate assembly 12, and tabs 64 and 58 of the latch bolt assembly 14 and the pawl assembly 16, respectively, undergo no excessive forces during impact and therefore can be relatively weak without effecting the safety of passengers within the associated vehicle.

The areas B, C and D can be used to provide for a housing of the latch assembly 10. Tabs 64 and 58 can be used as operating features of the latch assembly. For example, tab 64 can be used as a stop tab as can tab 58. Alternatively, tabs 64 or 58 can be used to actuate a micro switch to indicate, for example, a door a jar condition.

If necessary, pawl assembly 16 and or latch bolt assembly 14 can be over molded with a plastic material. Such over molding can at least act to reduce the noise associated with operating the latch. However, such over molding is clearly not of a structural nature since the plastics material is unable to withstand relatively high loads. In particular such over molding would typically be absent those areas of the latch bolt assembly 14 and pawl assembly 16 (such as closed abutment surface 48 and abutment surface 66) which suffer high stresses during an impact.

In particular, the invention allows the use of laminations 20, 21 made from material of a non homogenous nature. Typically, such a material would be steel having a grain structural running in a particular direction. Depending on the particular application it may be advantageous to arrange this grain structure to run in the same direction on adjacent laminations 20, 21. Alternatively, it may be advantageous to arrange the grain structure to run in the different directions on adjacent laminations 20, 21 of the retention plate 12 or latch bolt 14 or pawl assembly 16.

The invention provides for increasing the strength of safety critical structural components at specific areas likely to suffer high stresses whilst minimizing the weight of the assembly around areas of the assembly that are not likely to suffer high stresses and can therefore afford to be weaker.

The latch mechanism 10 is preferably lockable though need not be. In particular certain emergency vehicles such as fire engines are specifically designed to have doors which cannot lock (thereby ensuring access to the vehicle by the firemen and women at all times) and the present invention is equally applicable to such vehicles.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A vehicle door latch mechanism for releasably retaining a door comprising:
a latch bolt having a closed condition capable of retaining a striker and an open condition capable of releasing said striker;
a pawl releasably securing said latch bolt in said closed condition; and
a retention plate including at least one mouth co-operating with said latch mechanism to releasably retain said striker, an at least one pivot pin hole defining a pivot pin hole surface for a pivot pin, and at least one fixing system for fixing said latch mechanism in an operating position, said latch bolt, said pawl and said retention plate cooperating to releasably retain said striker and at least one of said latch bolt, said pawl and said retention plate is made from a plurality of structural laminations of material.

2. The latch mechanism as recited in claim 1 wherein said pivot pin is secured to said retention plate in said pivot pin hole.

3. The latch mechanism as recited in claim 1 wherein said pivot pin is pivotally mounted in said pivot pin hole.

4. The latch mechanism as recited in claim 1 wherein said latch bolt includes a plurality of latch bolt laminations.

5. The latch mechanism as recited in claim 4 wherein said plurality of latch bolt laminations combine to form a closed abutment surface, a first safety abutment surface for contact with said pawl of said latch mechanism, a retention surface for engagement with said striker associated with said latch mechanism and a latch pivot pin surface.

6. The latch mechanism as recited in claim 1 wherein said pawl includes a plurality of pawl laminations.

7. The latch mechanism as recited in claim 6 wherein said plurality of pawl laminations combine to form an abutment surface for engagement with a closed abutment surface and first safety abutment surface of said latch bolt and a pawl pivot pin surface.

8. The latch mechanism as recited in claim 1 wherein said retention plate includes a plurality of plate laminations.

9. The latch mechanism as recited in claim 8 wherein said plurality of plate laminations which combine to form said mouth for receiving said striker and a plate pivot pin hole.

10. The latch mechanism as recited in claim 8 wherein said plurality of plate laminations co-operate to provide said fixing system to secure said latch mechanism operably in position.

11. The latch mechanism as recited in claim 1 wherein one of said plurality of laminations includes a tab.

12. The latch mechanism as recited in claim 11 wherein said tab is located on said latch bolt and is for engagement with a chassis of said latch mechanism.

13. The latch mechanism as recited in claim 11 wherein said tab is located on said pawl.

14. The latch mechanism as recited in claim 11 wherein said tab is located on said retention plate.

15. The latch mechanism as recited in claim 1 wherein at least one of said plurality of laminations is non homogeneous such that a strength of said lamination as measured a in first direction is different from a strength of said lamination as measured in a second direction.

16. The latch mechanism as recited in claim 15 wherein a first lamination and a second lamination are non homogeneous with a strength of each of said laminations as measured in a respective first direction being different from a strength of said laminations as measured in a respective second direction, said respective first directions of said first and second laminations being aligned.

17. The latch mechanism as recited in claim 15 wherein a first lamination and a second lamination are non homogeneous with a strength of each of said laminations as measured in a respective first direction being different from a strength of said laminations as measured in a respective second direction, said respective first directions of said first and second laminations being misaligned.

18. The latch mechanism as recited in claim 15 wherein said plurality of laminations are made from steel having a grain structure.

19. The latch mechanism as recited in claim 1 wherein said plurality of laminations are at least partially over molded by a non structural plastics material.

20. The latch mechanism as recited in claim 19 wherein said plurality of partially over molded laminations are partially secured by said over molding.
